(19) United States
(12) Patent Application Publication
(10) Pub. No.: US 2002/0151987 A1
(43) Pub. Date: Oct. 17, 2002

(54) Cascading PID control loops in CMP process

(76) Inventor: Rafael Mendez, Chandler, CA (US)

Correspondence Address: Laura J. Zeman, SNELL & WILMER L.L.P., One Arizona Center, 400 East Van Buren, Phoenix, AZ, 85004-2202, US

(21) Appl. No.: 09/834,456

(22) Filed: Apr. 13, 2001

(51) Int. Cl. G05B 11/01

(52) U.S. Cl. 700/8; 700/2; 700/42

(57) ABSTRACT

The invention is a method and apparatus for interconnecting a plurality of control systems used to planarize wafers in a CMP tool. Example control systems that may be used with the invention are the back-fill pressure of a carrier, carrier down-force, carrier rotation and platen rotation. A controller is used to automate the CMP tool by communicating desired set-points to the various control systems. The instability or fluctuations in control systems caused by a desired change in one or more other control systems are reduced by allowing the affected control systems to receive information regarding the intended actions by the control systems that affect them. In this manner the affected control systems may take proactive steps to reduce fluctuations in their output caused by changes in the other control systems.

### TECHNICAL FIELD

The invention relates generally to semiconductor manufacturing, and more specifically to using proportional integrated derivative (PID) control loops to improve the interaction between various control systems in a chemical-mechanical polishing (CMP) tool.

### BACKGROUND OF THE INVENTION

A flat disk or “wafer” of single crystal silicon is the basic substrate material in the semiconductor industry for the manufacture of integrated circuits. Semiconductor wafers are typically created by growing an elongated cylinder or boule of single crystal silicon and then slicing individual wafers from the cylinder. The slicing causes both faces of the wafer to be extremely rough. The front face of the wafer on which integrated circuitry is to be constructed must be extremely flat in order to facilitate reliable semiconductor junctions with subsequent layers of material applied to the wafer. Also, the material layers (deposited thin film layers usually made of metals for conductors or oxides for insulators) applied to the wafer while building interconnects for the integrated circuitry must also be made a uniform thickness.

Planarization is the process of removing projections and other imperfections to create a flat planar surface, both locally and globally, and/or the removal of material to create a uniform thickness for a deposited thin film layer on a wafer. Semiconductor wafers are planarized or polished to achieve a smooth, flat finish before performing process steps that create integrated circuitry or interconnects on the wafer. A considerable amount of effort in the manufacturing of modern complex, high density multilevel interconnects is devoted to the planarization of the individual layers of the interconnect structure. Nonplanar surfaces create poor optical resolution of subsequent photolithography processing steps. Poor optical resolution prohibits the printing of high density lines. Planar interconnect surface layers are required in the fabrication of modern high density integrated circuits. To this end, CMP tools have been developed to provide controlled planarization of both structured and unstructured wafers.

A CMP planarization process that is able to repeatedly deliver a desired planarization result requires tight control over as many of the control systems that effect the planarization process as possible. CMP tools vary in design and thus vary in the control systems that they use. Typical CMP control systems control the pressure exerted on the back surface of a wafer by a carrier (back-fill pressure), the downforce of the carrier, the movement of the polishing pad and/or the movement of the carrier. While four typical control systems are specifically listed, not every CMP tool includes all four of these control systems. Additional control systems may also be needed by the CMP tools.

Conventional CMP tools typically use a feedback loop for each control system to continually adjust the control system and to maintain a desired process. Tightly controlled systems are essential in producing a repeatable planarization process. Allowing any of these control systems to vary from a desired state or transition during the planarization process, even if only temporarily, may cause the planarization process to become unstable. Applicant has noticed that many of the control systems in a CMP tool have unintended effects on other control systems. Every CMP tool design has different control systems with different unintended interactions between control systems.

Four specific examples of control systems common to many CMP tools that typically interact with each other are the carrier back-fill pressure, carrier down-force, carrier rotation and platen rotation control systems. It should be noted that not all four of these control systems will be in every CMP tool and when they are present, they may effect, and be effected by, other control systems. The carrier back-fill pressure control system controls the pressure within one or more plenums situated adjacent the back surface of a wafer. The carrier down-force control system controls how hard the front surface of the wafer is pressed against the polishing pad supported on the platen. The carrier rotation control system controls how rapidly the carrier is rotated, generally about the central axis of the carrier. The platen rotation control system controls how rapidly the platen, and thus the polishing pad, is rotated, generally about the central axis of the platen.

Applicant noticed that when one of these control systems is altered during the planarization process, the other control systems are also affected. As a specific example, when the control system for the carrier back-fill pressure is altered during the planarization process, the control systems for the carrier down-force, carrier rotation and platen rotation all experience undesirable fluctuations. The interrelationships between the control systems hinder a controlled planarization process where all the systems maintain a desirable state or transition.

What is needed is a method and apparatus for making desirable adjustments to one or more of the control systems while limiting the undesirable fluctuations in the other control systems. The method and apparatus should tightly control as many process critical control systems as possible while preventing desired changes in one control system from causing undesired changes in other control systems.

### SUMMARY OF THE INVENTION

The invention is an improved method and apparatus for maintaining a desired output from a plurality of interrelated control systems. A goal of the invention is to provide an improved CMP tool and planarization process with tightly controlled process parameters. A further goal of the invention is to minimize undesirable fluctuations in the control systems of the CMP tool caused by changes in other control systems. Another goal of the invention is to allow a plurality of control systems to communicate with each other so that one or more of the control systems may start to compensate, and thereby reduce fluctuations, caused by the desired changes in another control system. Another goal of the invention is to use a plurality of cascading PID control loops to control a respective plurality of control systems for a CMP tool.

Cascading PID control loops are able to anticipate and control changes within an interrelated group of control systems. Interactions between mechanical, electrical and/or pneumatic control systems are more easily controlled by communicating an expected change in state by one control system with the various other control systems. Cascading PID control loops allow the control systems to adjust proactively rather than having to wait and then react to changes within the environment. The use of PID control loops enables the various control systems to receive information from the other control systems and to then start making necessary adjustments sooner to compensate for changes among the other various control systems. These quick adjustments enhance tight control over all the control systems during the planarization process.

A controller, e.g., computer system, may be used to advantageously automate the various control systems of the CMP tool. The controller may be used to coordinate the timing and set-points for the various control systems of the CMP tool. Control systems typically comprise a comparator, control algorithm, output sensor and regulator. Examples of process parameters for the various control systems that may be regulated are the carrier backfill pressure, carrier down-force, carrier rotational speed, and platen rotational speed. The controller may send the desired set-points at the desired time to appropriate comparators to control, for example, the back-fill pressure, carrier down-force carrier rotational speed and platen rotational speed. The actual values may be read by appropriately placed output sensors. Each sensor may input its measured value into a corresponding comparator. A tracking error for each of the control systems may be calculated by subtracting the measured value from the desired set-point. The calculated tracking error for the various control systems may be transferred to respective control algorithms. The control algorithms are preferably PID control algorithms, but may also be P, PI, or PD control algorithms. The control algorithms may then send optimized signals to their respective hardware regulators, e.g., pressure regulator, carrier pneumatic cylinder, carrier motor or platen motor. The optimized signals will move the output of the control systems closer to their respective set-points. These feedback loops may advantageously be continuously repeated to maintain the various control systems at their desired set-point.

The actions of one of the control systems may cause fluctuations or instabilities in the other control systems. Specifically, it may be found that the CMP process may be improved by altering a first control system during the CMP process. Since the control systems affect each other, information regarding the operation of the first control system may be communicated to a second control system. The first control system may then adjust to, and maintain, the new set-point while the second control system compensates for the adjustment made by the first control system.

The control algorithms are advantageously tuned to send an optimum signal to their respective hardware regulators. The tuning process of the control algorithms needs to take account of the tracking error and the information from the other control systems. By proper tuning of the control algorithms, each control algorithm will be able to continuously calculate an optimum signal. The optimum control signal may then provide a steady control system by compensating for actions taken by the other control systems, thereby minimizing fluctuations in the planarization process. Fewer fluctuations will improve the planarization process and create a more stable CMP tool and process.

### BRIEF DESCRIPTION OF THE DRAWINGS

The present invention will hereinafter be described in conjunction with the appended drawing figures, wherein like numerals denote like elements, and:

FIG. 1 is a simplified side view of a CMP tool having four control systems;

FIG. 2 is a four control system layout showing the basic interconnectivity between the four control systems; and

FIG. 3 is a flowchart of a process that may be used to practice the present invention.

### DETAILED DESCRIPTION OF EXEMPLARY EMBODIMENTS

A method utilized in the polishing of semiconductor substrates and thin films formed thereon will now be described. In the following description, numerous specific details are set forth illustrating Applicant's best mode for practicing the present invention and enabling one of ordinary skill in the art to make and use the present invention. It will be obvious, however, to one skilled in the art that the present invention may be practiced without these specific details. In other instances, well-known machines and process steps have not been described in particular detail in order to avoid unnecessarily obscuring the present invention.

Cascading PID control loops are able to anticipate and control changes within an interrelated group of control systems. Interactions between mechanical, electrical and/or pneumatic control systems are more easily controlled by communicating an expected change in state by one control system with the various other control systems. Cascading PID control loops allow the control systems to adjust more quickly rather than having to wait and then react to changes within the environment. The use of PID control loops enables the various control systems to receive information from the other control systems and to then start making necessary adjustments sooner to compensate for changes among the other various control systems. These adjustments occur more quickly because the early information from the other control systems allows the individual control system to take a proactive role, instead of a much slower reactive role. Each cascading PID control loop should recognize and react to all transients and disturbances and should be able to minimize fluctuations in its own control system based on the feedback from the various other control systems. These quick adjustments enhance tight control over all the control systems during the planarization process.

Four specific examples of control systems that may be controlled using cascading PID control loops are a carrier back-fill pressure, carrier down-force, carrier rotation and platen rotation control systems. These four control systems are good candidates for using cascading PID control loops because of their importance to the planarization process and because of their interactions with each other. The invention will be described using these four control systems. However, it should be noted that not all four of these control systems will be used in every CMP tool design, and when they are present they may effect, and be effected by, other control systems. Control systems that strongly influence the quality of the planarization process and that affect, or are affected by, other control systems may also advantageously be used with cascading PID control loops.

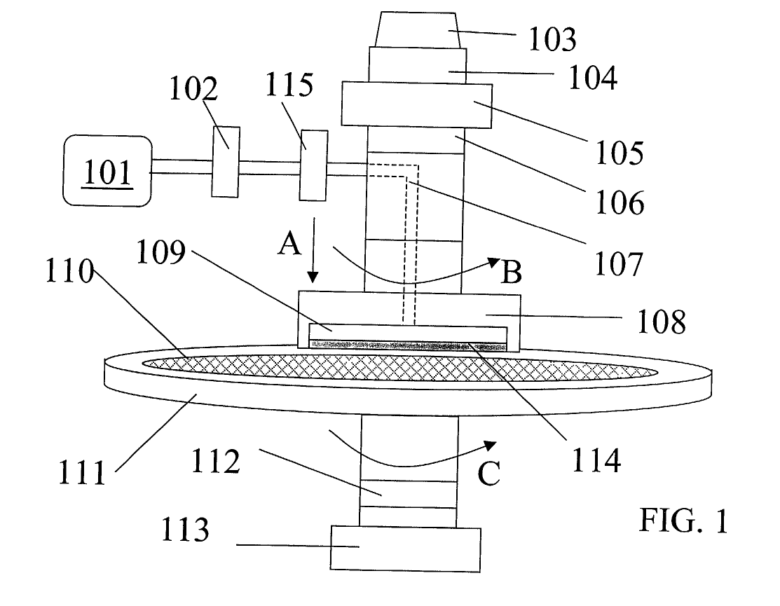

Four illustrative control systems that may be used to practice the invention will now be discussed in detail with reference to FIG. 1. The carrier back-fill pressure control system is used to control the pressure within a plenum 109 formed inside a carrier 108. The plenum 109 may be separated into multiple independently controllable pressure plenums to allow different areas on the back surface of the wafer 114 to receive different pressures. This allows great flexibility in customizing the planarization process. In addition, a membrane (not shown) may be placed between the wafer 114 and the plenum 109 to prevent fluid or debris from entering the plenum 109. Of course, some CMP tools support the back surface of a wafer by a film in which case the carrier back-fill pressure control system is not needed. However, when this control system is used, it provides for a uniform pressure(s) to be placed against the back surface of the wafer 114.

The carrier back-fill control system may utilize a pump 101 to generate either a pressure or a vacuum. The pressure or vacuum typically range between negative 15 and positive 30 psi, depending on the needs of the planarization process. The pressure or vacuum may be regulated by a pressure regulator 102 and may be communicated to the plenum 109 through a rotary union 115 and passages in the carrier 108. The actual pressure may be read by a pressure sensor 115.

The carrier back-fill control system alters the pressure within the plenum 109 thereby interfering with the down-force on the wafer 114 created by the carrier down-force control system. An increase or decrease in the pressure within the plenum 109 caused by the carrier back-fill control system will require a compensating decrease or increase pressure by the carrier down-force control system to maintain a steady down-force. In addition, an increase or decrease in pressure by the carrier back-fill control system will cause a corresponding increase or decrease in friction by the wafer 114 against the polishing pad 110 mounted on a platen 11. The increase or decrease in friction will cause a corresponding decrease or increase in rotation speed for the carrier and platen. The carrier rotation control system and platen rotation control system will need to compensate for the altered friction between the wafer 114 and the polishing pad 110. The net result is that the other three control systems must compensate as quickly as possible to the changes in the CMP tool environment caused by the carrier back-fill control system.

The carrier down-force control system adjusts the down-force experienced by the carrier 108. The down-force may be generated by hydraulics or electrical motors, but is preferably generated by pneumatics. A pneumatic cylinder 103 may be rigidly supported by the CMP tool and press the carrier 108, via a shaft, and the wafer 114 against the polishing pad 110. The down-force is typically between about 0 and 300 lbs. for many CMP processes. As the down-force is being applied to the carrier 108, a load sensor 104 may be used to measure the actual down-force.

The carrier down-force control system alters the down-force on the carrier 108 thereby interfering with the pressure within the plenum 109 created by the carrier back-fill pressure control system. An increase or decrease in the pressure by the carrier down-force control system will require a compensating decrease or increase pressure within the plenum 109 caused by the carrier back-fill control system to maintain a pressure within the plenum 109. In addition, an increase or decrease in pressure by the carrier down-force control system will cause a corresponding increase or decrease in friction by the wafer 114 against the polishing pad 110 mounted on a platen 111. The increase or decrease in friction will cause a corresponding decrease or increase in rotation speed for the carrier and platen. The carrier rotation control system and platen rotation control system will need to compensate for the altered friction between the wafer 114 and the polishing pad 110. Therefore, the other three control systems must compensate, preferably as quickly as possible, to the changes in the CMP tool environment caused by the carrier down-force control system.

The carrier rotation control system may be used to rotate the carrier 108, preferably about the central axis of the carrier 108. Rotation of the carrier 108 helps average out problems caused by defects in the polishing pad 110 that otherwise would repeatedly pass over the same portions of the wafer 114. In addition, the rotation of the carrier 108 averages out problems associated with hydroplaning of the wafer 114. However, it should be noted that a carrier rotation control system is not needed by every CMP tool design. In fact, the carrier rotation control system causes a problem by creating nonuniform motion between the wafer 114 and the polishing pad 110. Areas further from the center of the wafer 114 experience additional relative motion compared to areas near the center of the wafer 114 due to the rotation of the wafer 114. The carrier 114 may be rotated in either direction but is preferably rotated counter-clockwise. The carrier 114 may also be repeatedly rotated first in one direction a certain amount, for example about 90 to 180 degrees, and then may be rotated in the other direction a similar distance.

The carrier rotation control system preferably includes an electrical carrier motor 105 connected to the carrier 108 for rotating the carrier 108. A carrier rotation sensor 106 may be used to accurately determine the rotational speed of the carrier 108. The carrier rotation control system is thus able to rotate the carrier 108 as the wafer 114 is pressed against the polishing pad 110 and accurately measure its rotational speed. Typical rotational speeds vary between about 0 and 20 rpms for many CMP processes.

A change in the rotational speed of the carrier 108 by the carrier rotational control system alters the other control systems. This is due primarily to imperfections in the carrier motor 105 and altered hydroplaning and frictional forces between the wafer 114 and the polishing pad 110. These factors cause fluctuations in the plenum 109 pressure controlled by the back-fill pressure control system, the carrier down-force controlled by the carrier downforce control system and the platen rotational speed controlled by the platen rotational speed control system.

The platen rotational control system may be used to control the rotational speed of the platen 111. A polishing pad 110 may be adhered to the platen 111 making the rotational speed of the platen 111 critical to the planarization process. The movement of the platen 111 and polishing pad 110 are preferably the primary generator of relative motion between the front surface of the wafer 114 and the polishing pad 110. Typically, rotational speeds for the platen 111 are between 10 and 90 rpms in the counter-clockwise direction with increased rotational speeds producing increased material removal rates from the front surface of the wafer. Of course, other types of motions, e.g., orbital, linear, vibrational, etc., may be created by a suitably designed platen rotational control system if desired.

The platen rotational control system preferably includes means for rotating the platen, such as an electrical motor 113 rigidly mounted to the CMP tool. A platen rotational sensor 112 may be part of the electrical motor 113 or may be a separate instrument able to accurately measure the rotational speed of the platen 111.

A change in the rotational speed of the platen 111 by the platen rotational control system also alters the other control systems. This is primarily due to imperfections in the platen motor 105 and planarity of the platen 111 and altered hydroplaning and frictional forces between the wafer 114 and the polishing pad 110. These factors cause fluctuations in the plenum 109 pressure controlled by the back-fill pressure control system, the carrier downforce controlled by the carrier down-force control system and the carrier rotational speed controlled by the carrier rotational speed control system.

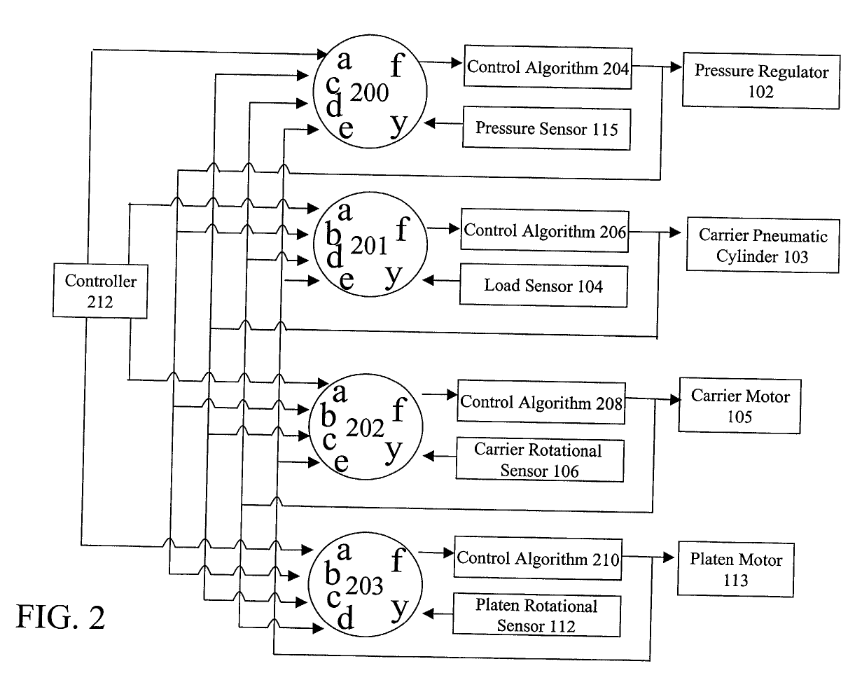

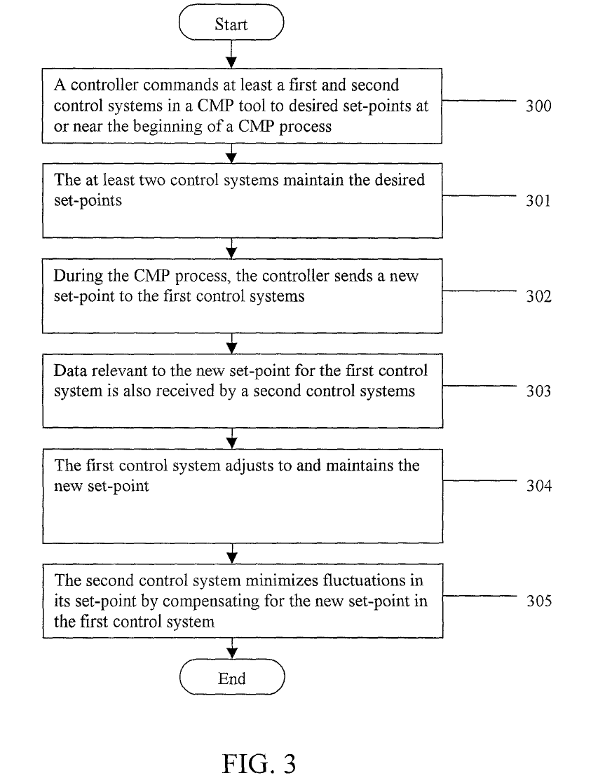

A controller 212, e.g., computer system, may be used to advantageously automate the various control systems of the CMP tool. FIG. 2 illustrates the interconnectivity between the control systems and FIG. 3 illustrates an example flowchart for the process. The controller 212 may be used to coordinate the timing and set-points for the desired back-fill pressure, carrier down-force, carrier rotational speed and platen rotational speed. The controller 212 may send the desired set-points at the desired time to comparator 200a, 201a, 202a and 203a to respectively control the back-fill pressure, carrier down-force, carrier rotational speed and platen rotational speed. (Step 300) The actual current back-fill pressure, carrier down-force, carrier rotational speed and platen rotational speed may respectively be measured by a pressure sensor 115, load sensor 104, carrier rotational sensor 106 and platen rotational sensor 112. The pressure sensor 115, load sensor 104, carrier rotational sensor 106 and platen rotational sensor 112 may input this measured value into comparator 200y, 201y, 202y and 203y, respectively. A tracking error for each of the control systems may be calculated by subtracting the measured value from the desired set-point. The tracking error for the back-fill pressure, carrier down-force, carrier rotational speed and platen rotational speed may then be transferred to control algorithms 204, 206, 208 and 210, respectively. The control algorithms are preferably PID control algorithms, but may also be P, PI, or PD control algorithms. If a PID control algorithm is used, an integral and derivative of the tracking error will be calculated to determine the optimum signal to send to the various devices to stabilize the planarization process. The control algorithms 204, 206, 208 and 210 may then send the optimized signal to their respective pressure regulator 102, carrier pneumatic cylinder 103, carrier motor 105 and platen motor 113. The optimized signals will move the back-fill pressure, carrier down-force, carrier rotation and platen rotation closer to their respective set-points. These feedback loops may advantageously be continuously repeated to maintain the various control systems at their desired set-point. (Step 301)

As previously discussed, the actions of one of the control systems may cause fluctuations or instabilities in the other control systems. Specifically, it may be found that the CMP process may be improved by altering a first control system during the CMP process. (Step 302) Since the control systems affect each other, information regarding the operation of the first control system may be communicated to at least a second control system. (Step 303) In general, control systems that do not affect other control systems or have only a minimal affect may be excluded from sharing their information as this will likely simplify the communications between the control systems. The first control system may then adjust to and maintain the new set-point (step 304) while the at least second control system compensates for the adjustment made by the first control system (step 305).

FIG. 2 illustrates one possible arrangement for sharing information between control systems. In this example, the control algorithms 204, 206, 208 and 210 send information not only to the pressure regulator 102, carrier pneumatic cylinder 103, carrier motor 105, and platen motor 113, but also to the other comparators. Specifically, control algorithms 204, 206, 208 and 210 may communicate with comparators 201b, 202b and 203b; 200c, 202c and 203c; 200d, 201d and 203d; and 200e, 201e and 202e, respectively. Comparators 200, 201, 202 and 203 may then transfer this information to their control algorithm 204, 206, 208 and 210, respectively. Alternatively, the information from each of the control algorithms may also have been communicated directly to the other control algorithms thereby skipping the comparators.

The control algorithms 204, 206, 208 and 210 are advantageously tuned to send an optimum signal to the pressure regulator 102, carrier pneumatic cylinder 103, carrier motor 105 and platen motor 113. The tuning process for the control algorithms may be determined empirically, by the Ziegler Nichols tuning method or by other known tuning processes. The tuning process of the control algorithms needs to account of the tracking error and the information from the other control systems. By proper tuning of the control algorithms, each control algorithm will be able to provide a steady control system by compensating for actions taken by the other control systems, thereby minimizing fluctuations in the planarization process. Fewer fluctuations will improve the planarization process and create a more stable CMP tool and process.

While the invention has been described with regard to specific embodiments, those skilled in the art will recognize that changes can be made in form and detail without departing from the spirit and scope of the invention. For example, only a few of the possible control systems that may be involved in the planarization process were listed and discussed. Other control systems may also be incorporated into the PID control loops to further enhance the control over the planarization process. For example, the control system for slurry delivery may also be incorporated into the PID control loops. Also, the four control systems that were described were described generically. Different methods of controlling the carrier back-fill pressure, carrier downforce, carrier rotation and platen rotation may be used. For example, while the platen was described as rotating, it could also be orbited or moved linearly with a corresponding control system.

I claim:

1. A tool for planarizing workpieces, comprising:
a controller;
a first and a second control system wherein the first control system is affected by the operation of the second control system;
a first communication path from the controller to the first control system;
a second communication path from the controller to the second control system; and
a third communication path from the second control system to the first control system.

2. The tool of claim 1 wherein the first control system comprises:
a first regulator for adjusting an output of the first control system;
a first sensor for monitoring the output of the first control systems;
a first control algorithm in communication with the controller along the first communication path, the second control system along the third communication path, and the first sensor; and
a fourth communication path from the first control algorithm to the first regulator.

3. The tool of claim 2 wherein the second control system comprises:
a second regulator for adjusting an output of the second control system;
a second sensor for monitoring the output of the second control systems;
a second control algorithm in communication with the controller along the first communication path and the second sensor; and
a fifth communication path from the second control algorithm to the second regulator.

4. The tool of claim 2 wherein the first control system further comprises:
a first comparator positioned in the first communication path between the controller and the first control algorithm and positioned between the first sensor and the first control algorithm.

5. The tool of claim 2 wherein the first control algorithm comprises a proportional, proportional integral, proportional derivative or proportional integral derivative control algorithm.

6. The tool of claim 5 wherein the first control algorithm is tuned.

7. The tool of claim 2 wherein the first control system comprises a carrier back-fill control system, carrier down-force control system, carrier rotation control system or platen rotation control system.

8. The tool of claim 6 wherein the second control system comprises a carrier back-fill control system, carrier down-force control system, carrier rotation control system or platen rotation control system and the second control system is different from the first control system.

9. A tool for planarizing wafers, comprising:
a controller;
a plurality of control systems;
a plurality of communication paths, wherein at least one communication path is placed between the controller and each control system; and
a communication path placed between a first and a second control system, wherein the second control system affects the operation of the first control system.

10. The tool of claim 9 wherein the first control system comprises:
a control algorithm;
a sensor for measuring an output of the first control system, wherein the sensor is in communication with the control algorithm; and
a regulator for controlling the output of the first control system, wherein the control algorithm is in communication with the regulator.

11. The tool of claim 9 wherein the control algorithm comprises a proportional, proportional integral, proportional derivative or proportional integral derivative control algorithm.

12. A tool for planarizing wafers, comprising:
a plurality of control systems, wherein each control system is in communication with every other control system; and
a controller in communication with each control system;
wherein each control system comprises an output sensor, a regulator and a control algorithm, wherein each control algorithm calculates an optimized signal, based on input from the controller, output sensor and other control systems, to communicate to the regulator.

13. The tool of claim 12 wherein the control algorithm is selected from a proportional, proportional integral, proportional derivative or proportional integral derivative control algorithm.

14. The tool of claim 13 wherein the output sensor is selected from a pressure sensor, load sensor, carrier rotational sensor or platen rotational sensor.

15. The tool of claim 13 wherein at least one of the control systems is selected from a carrier back-fill pressure, carrier down-force, carrier rotational and platen rotational control system.

16. A method for planarizing a workpiece, comprising the steps of:
a controller commanding a first control system to output a first set-point;
the controller commanding a second control system to output a second set-point, wherein the output of the second control system affects the output of the first control system;
planarizing the workpiece;
the controller commanding the second control system to output a third set-point;
communicating information regarding the third set-point of the second control system to the first control system;
adjusting the output of the second control system to the third set-point; and
maintaining the output of the first control system by compensating for the adjustment of the second control system from the second set-point to the third set-point.

17. The method of claim 16 wherein a control algorithm is used to compensate for the adjustment of the second control system from the second set-point to the third set-point.

18. The method of claim 17 wherein the control algorithm is selected from a proportional, proportional integral, proportional derivative or proportional integral derivative control algorithm.

19. A method for planarizing workpieces, comprising the steps of:
a) communicating a first set-point from a controller to a first comparator;
b) communicating a second set-point from the controller to a second comparator;
c) communicating an output from a first sensor of a first control system to the first comparator;
d) communicating an output from a second sensor of a second control system to the second comparator;
e) calculating a first tracking error by the first comparator;
f) calculating a second tracking error by the second comparator;
g) communicating the first tracking error from the first comparator to a first control algorithm;
h) communicating the second tracking error from the second comparator to a second control algorithm;
i) communicating information related to changes in the second control system to the first control algorithm;
j) communicating information related to changes in the first control system to the second control algorithm;
k) calculating a first optimized signal by the first control algorithm;
l) calculating a second optimized signal by the second control algorithm;
m) communicating a first optimized signal to a first regulator from the first control algorithm;
n) communicating a second optimized signal to a second regulator from the second control algorithm; and
o) repeating steps c-l until the controller alters the first or second set-point or the workpiece is planarized.

20. The method of claim 19 wherein the first control algorithm comprises a proportional, proportional integral, proportional derivative or proportional integral derivative control algorithm.

21. The method of claim 20 wherein the first control algorithm is tuned.

22. The method of claim 20 wherein the first control system comprises a carrier back-fill control system, carrier down-force control system, carrier rotation control system or platen rotation control system.

23. The method of claim 22 wherein the second control system comprises a carrier backfill control system, carrier down-force control system, carrier rotation control system or platen rotation control system and the second control system is different from the first control system.
